(19) United States
(12) Patent Application Publication
(10) Pub. No.: US 2025/0303590 A1
(43) Pub. Date: Oct. 2, 2025

(54) ROBOTIC WRIST DEVICE WITH VARIABLE STIFFNESS

(71) Applicant: KOREA INSTITUTE OF SCIENCE AND TECHNOLOGY, Seoul (KR)

(72) Inventors: Donghyun HWANG, Seoul (KR); Hyun Soo SUN, Seoul (KR)

(73) Assignee: KOREA INSTITUTE OF SCIENCE AND TECHNOLOGY, Seoul (KR)

(21) Appl. No.: 18/813,380

(22) Filed: Aug. 23, 2024

(30) Foreign Application Priority Data
Apr. 2, 2024 (KR) 10-2024-0044771

(51) Int. Cl. B25J 17/02

(52) U.S. Cl. CPC B25J 17/0208

(57) ABSTRACT

Disclosed is a robotic wrist device with variable stiffness including: a base part; a fixing part including a plurality of actuators; a central part including a socket part formed in an upper direction; a moving part including a downwardly extending ball joint, and an elastic member having an inner circumference coupled to the central part at a periphery of the central part and an outer circumference coupled to an outer peripheral portion of the moving part, in which the moving part is capable of tilting movement relative to the central part in response to rotation of the ball joint, and the moving part includes a plurality of connection parts which are connected to the fixing parts through wires connected to the plurality of actuators, respectively.

### CROSS REFERENCE TO RELATED APPLICATION

The present application claims priority to Korean Patent Application No. 10-2024-0044771, filed on Apr. 2, 2024, the entire contents of which is incorporated herein for all purposes by this reference.

### BACKGROUND OF THE INVENTION

### Field of the Invention

The present invention relates to a robotic wrist device with variable stiffness, and particularly, to a robotic wrist device with variable stiffness, which is capable of changing a mode to a rigid mode that fixes the stiffness of a robotic wrist device by adjusting the tension of wires, and a compliant mode that allows the robotic wrist device to adapt to external force by removing stiffness.

### Description about National Research and Development Support

This study was supported by the technology development program of Ministry of Science and ICT, Republic of Korea (Project No. 1711168929) under the Korea Institute of Science and Technology.

### Description of the Related Art

To date, most robotic systems consisting of the robot manipulator and the end-effector (for example, gripper or hand) are widely utilized in various industrial fields, and the robotic systems interact with the environment in various areas and are primarily based on physical contact.

The interaction between the robot and the environment may be applied, for example, to detect force or provide feedback by utilizing tactile sensors mounted on a robot, or to physical interaction fields with control algorithms based on force or torque sensors.

However, the rigid-type robots, which exert interaction by applying force/torque sensor-based control algorithms, still require very complex designs and have difficulty in providing stable interactions that may respond to unexpected collisions or contacts.

To complement the stable interaction described above, methods have been employed to adjust the stiffness of the robotic wrist device by using flexible materials for the body of the robot, or by utilizing variable stiffness actuators or series elastic structures.

However, the previously proposed robotic wrist device is limited in application due to the bulky design for the manipulator and end-effector system and functional limitations according to structural rigidity, so that there is a limit to being applied to various systems.

For example, the robotic wrist device with structurally secured stiffness allows for precise manipulation, but has the disadvantage of not being able to flexibly adapt to an unstructured external environment. Conversely, the robotic wrist device structure with small stiffness flexibly adapts to the external environment, but is limited in its ability to perform precise manipulations.

### SUMMARY OF THE INVENTION

The present invention has been made in an effort to develop a device that is capable of selectively changing stiffness while remaining flexible, not only in operations where a robot simply maintains constant force to contact a surface of a work object, but also in operations where force applied to an object changes depending on a stage of the operation.

In order to achieve the foregoing technical problems, the present invention may provide a robotic wrist device with variable stiffness including: a base part; a fixing part disposed on a top portion of the base part and including a plurality of actuators; a central part disposed on a top portion of the fixing part and including a socket part formed in an upper direction; a moving part including a downwardly extending ball joint, and supported on the central part by the ball joint being inserted into and supported on the socket part; and an elastic member having an inner circumference coupled to the central part at a periphery of the central part and an outer circumference coupled to an outer peripheral portion of the moving part, in which the moving part is capable of tilting movement relative to the central part in response to rotation of the ball joint, and the moving part includes a plurality of connection parts which are connected to the fixing parts through wires connected to the plurality of actuators, respectively.

Further, the elastic member may adopt a circular diaphragm spring, and the diaphragm spring may include: an inner rim engaged with the central part; an outer rim engaged with the outer peripheral portion of the moving part; and a sheet disposed between the inner rim and the outer rim.

Further, in the sheet of the diaphragm spring of the present invention, a plurality of slits disposed concentrically with the inner rim and the outer rim is formed.

Further, the position of the inner rim of the diaphragm spring is fixed and the outer rim is movable in response to movement of the outer peripheral portion of the moving part.

Further, the plurality of actuators may be disposed in the same angular phase around the circumference of the fixing part, and particularly, the plurality of actuators may be three, and be disposed at an angle of 120° around the circumference of the fixing part.

Further, the ball joint of the present invention may further include a magnetic material, the central part may further include a circuit unit including a magnetic sensor, and according to the tilting of the moving part, the movement of the magnetic material may be detected by the magnetic sensor, such that a rotation angle of the ball joint is detected.

Further, the plurality of actuators each of the present invention is capable of limiting tilting movement of the moving part by applying tension to the wire.

Further, the base part of the present invention may further include a circuit unit for controlling driving of the plurality of actuators.

The present invention may provide the robotic wrist device with variable stiffness, which may fix stiffness of a robotic wrist to precisely manipulate a position, and also secure a compliance function by removing stiffness of the robotic wrist as needed.

Furthermore, the present invention may provide the robotic wrist device of which the entire system is capable of switching an operation mode to the rigid mode depending on the environment without the need for a separate device as an independent module form.

### BRIEF DESCRIPTION OF THE DRAWINGS

FIG. 1A is a perspective view schematically illustrating a structural characteristic of a robotic wrist device according to an exemplary embodiment of the present invention, and FIG. 1B is a conceptual view schematically illustrating application of the robotic wrist device according to the exemplary embodiment of the present invention to a robot.

FIG. 2 is an exploded perspective view schematically illustrating the robotic wrist device according to the exemplary embodiment of the present invention.

FIG. 3 is a cross-sectional view of the robotic wrist device according to the exemplary embodiment of the present invention.

FIG. 4 is a bottom perspective view of a moving part of a robotic wrist device according to the exemplary embodiment of the present invention.

FIG. 5 is a perspective view schematically illustrating a diaphragm spring according to the exemplary embodiment of the present invention.

FIG. 6 is a diagram schematically illustrating the behavior of the diaphragm spring according to the exemplary embodiment of the present invention.

FIG. 7 is a conceptual diagram illustrating the operation relationship of the diaphragm spring according to the behavior of the moving part according to the exemplary embodiment of the present invention.

FIG. 8 is a conceptual diagram schematically illustrating an operation mode according to adjusting tension of a wire of the robotic wrist device according to the exemplary embodiment of the present invention.

FIG. 9 is a conceptual diagram schematically illustrating a method of measuring a tilt of the moving part of the robotic wrist device according to the exemplary embodiment of the present invention.

FIG. 10 is a perspective view schematically illustrating an actuator mounted on the robotic wrist device according to the exemplary embodiment of the present invention.

FIG. 11A and FIG. 11B are conceptual diagrams schematically illustrating the behavior of the robotic wrist device in (a) a compliant mode and (b) a rigid mode according to the exemplary embodiment of the present invention.

FIG. 12 is a photograph schematically illustrating the behavior of a robotic hand using the robotic wrist device according to the exemplary embodiment of the present invention.

### DETAILED DESCRIPTION OF THE INVENTION

Hereinafter, a robotic wrist device with variable stiffness according to the present invention will be described with reference to the accompanying drawings, with reference to an exemplary embodiment of the invention.

In the following description, in various exemplary embodiments, a representative exemplary embodiment will be described by using the same reference numeral for components having the same configuration, and only different components will be described in other exemplary embodiments.

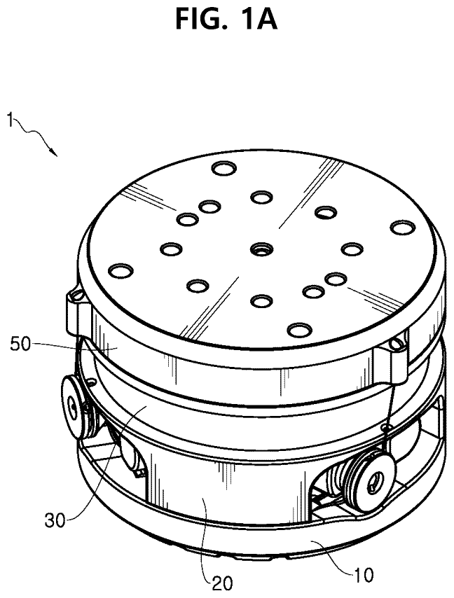

FIG. 1A is a perspective view schematically illustrating a structural characteristic of a robotic wrist device according to an exemplary embodiment of the present invention, and FIG. 1B is a conceptual view schematically illustrating application of the robotic wrist device according to the exemplary embodiment of the present invention to a robot.

As illustrated in FIG. 1B, a robotic wrist device 1 according to an exemplary embodiment of the present invention may be mounted and applied between a robot manipulator and a robotic hand (for example, a gripper). Furthermore, the robotic wrist device 1 according to the exemplary embodiment of the present invention may be constructed independently without any additional components except for a power input device, and may have a structurally minimized size in consideration of the operating range and moment inertia of the robotic hand.

Specifically, the robotic wrist device 1 according to the exemplary embodiment of the present invention is a structure in which a fixing part 20 is disposed on a top portion of the base part 10, a central part 30 is disposed on a top portion of the fixing part 20, and a moving part 50 is disposed on a top portion of the central part 30. The specific configuration and operating relationship of the base part 10, the fixing part 20, the central part 30, and the moving part 50 will be described later.

Furthermore, the robotic wrist device 1 according to the exemplary embodiment of the present invention may be equipped with a robotic hand on the moving part 50 described above, and the base part 10 described above may be coupled to a manipulator, so that the robotic wrist device 1 may perform a function as a robotic wrist.

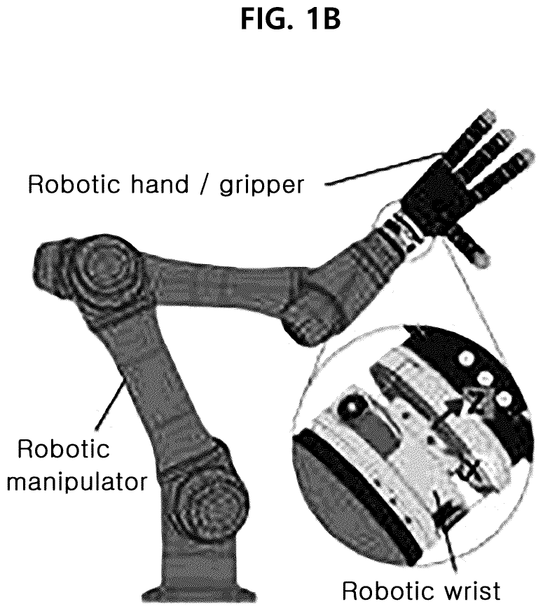

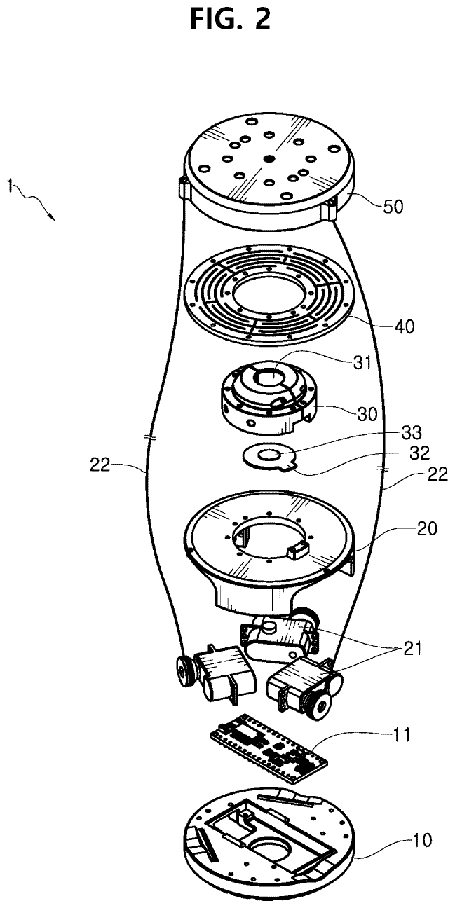

FIG. 2 is an exploded perspective view schematically illustrating the robotic wrist device 1 according to the exemplary embodiment of the present invention, and FIG. 3 is a cross-sectional view of the robotic wrist device 1 according to the exemplary embodiment of the present invention.

As illustrated in FIGS. 2 and 3, in the robotic wrist device 1 according to the exemplary embodiment of the present invention, the fixing part 20 is disposed on the top portion of the base part 10, and the fixing part 20 includes a plurality of actuators.

Further, the central part 30 is disposed on the top portion of the fixing part 20, and a concave socket part 31 facing in an upper direction is formed in the center of the central part 30.

Further, an clastic member 40 of which an inner circumference is coupled with the central part 30 and of which an outer circumference is coupled with the moving part 50 to be described later is disposed around the central part 30, and the moving part 50 is arranged on the top portion of the clastic member 40.

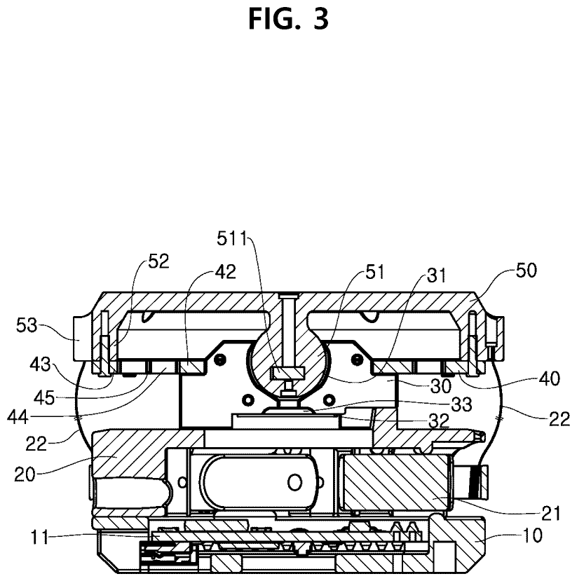

FIG. 4 is a bottom perspective view of the moving part 50 of the robotic wrist device 1 according to the exemplary embodiment of the present invention.

As illustrated in FIG. 4, a downwardly extending ball joint 51 is formed in the center of the moving part 50, and the ball joint 51 is inserted into and supported by the socket part 31 formed in the central part 30 described above, so that the moving part 50 may be supported on the central part 30.

Furthermore, since the ball joint 51 of the moving part 50 and the socket part 31 of the central part 30 have a spherical shape, the ball joint 51 may rotate in the interior of the socket part 31 according to the behavior of the robot hand (not illustrated), so that the moving part 50 may have a tilt motion relative to the central part 30.

The moving part 50 may also have a plurality of connection parts 53 formed on an outer circumference thereof, and each of the plurality of connection parts 53 may be coupled to the plurality of actuators 21 formed on the fixing part 20 via wires 22. The coupling of the connection parts 53 of the moving part 50 to the wires 22 may be made, for example, by screw bolt assembly or by fixing knots in the wires 22 to the connection parts 53 of the moving part 50 by using an adhesive.

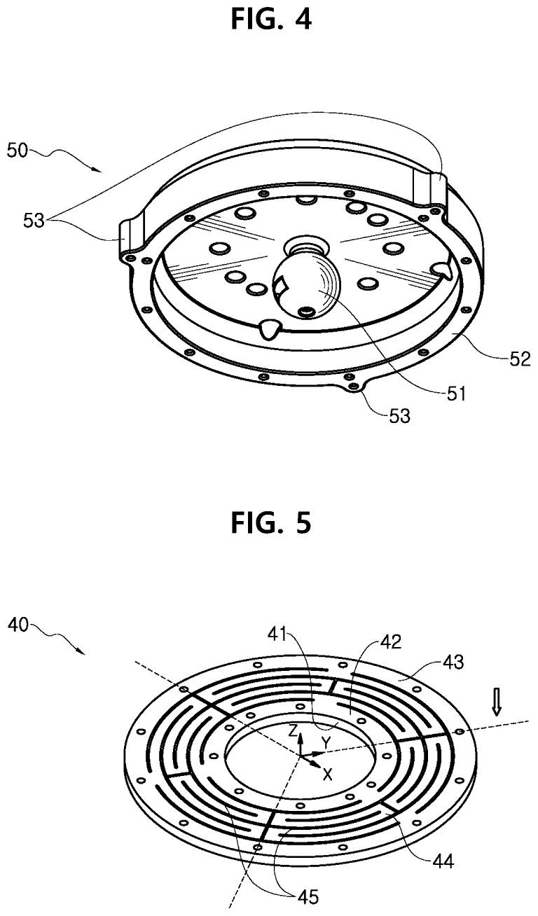

FIG. 5 is a perspective view schematically illustrating a diaphragm spring that is the clastic member 40 according to the exemplary embodiment of the present invention.

As illustrated in FIG. 5, the diaphragm spring may be formed of an inner rim 42 engaged with the central part 30, an outer rim 43 engaged with an outer periphery 52 of the moving part 50, and a sheet 44 disposed between the inner rim 42 and the outer rim 43. The engagement between the outer periphery 52 and the outer rim 43 of the moving part 50 may be accomplished, for example, by means of a screw bolt assembly.

Furthermore, the sheet 44 is formed with a plurality of slits 45 disposed concentrically with the inner rim 42 and the outer rim 43.

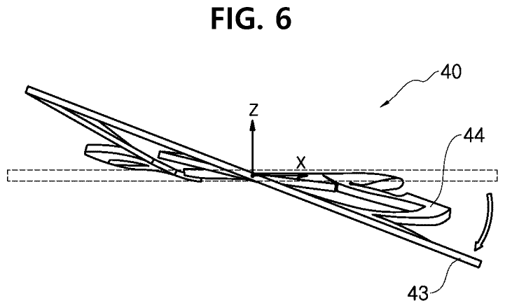

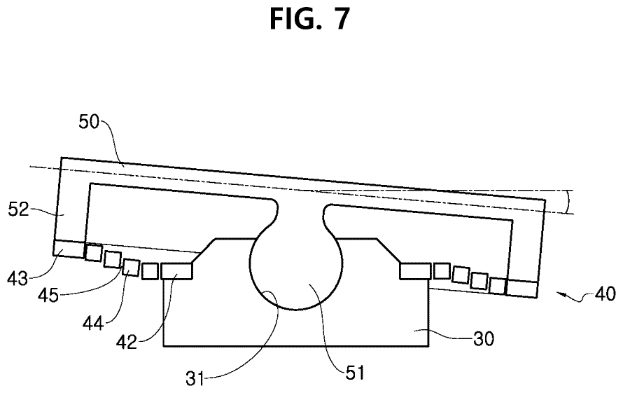

FIG. 6 is a diagram schematically illustrating the behavior of the diaphragm spring according to the exemplary embodiment of the present invention, and FIG. 7 is a conceptual diagram illustrating the operation relationship of the diaphragm spring according to the behavior of the moving part 50 according to the exemplary embodiment of the present invention.

In the exemplary embodiment of the present invention, the position of the inner rim 42 of the diaphragm spring is coupled to and fixed with the central part 30, and the outer rim 43 is movable in response to movement of the outer periphery 52 of the moving part 50.

Specifically, by introducing the clastic member 40 into the robotic wrist device 1, the robotic wrist device 1 may be made to behave flexibly. Accordingly, the elastic member 40 according to the exemplary embodiment of the present invention is formed of leaf springs, such as the diaphragm springs, each of which is symmetrically connected at 120° intervals in the circumferential direction.

Furthermore, the diaphragm spring according to the exemplary embodiment of the present invention may be formed of a polymeric material (for example, POM) that is lighter than a metallic material, and preferably a material with a large modulus of elasticity is used to allow for a large deflection.

Furthermore, the diaphragm spring according to the exemplary embodiment of the present invention may be easily fabricated as an integral body by plate laser cutting, which may reduce weight and assembly tolerances with other components.

As described above, because the ball joint 51 of the moving part 50 is supported on the central part 30, the z-axis movement of the diaphragm spring is limited and only angular movement in the x-axis and the y-axis is allowed, so that unwanted parasitic translation displacement of the moving part 50 is limited, which may prevent the occurrence of tip motion when external force is applied to the robotic hand, thereby allowing the occurrence of a controllable tilt motion.

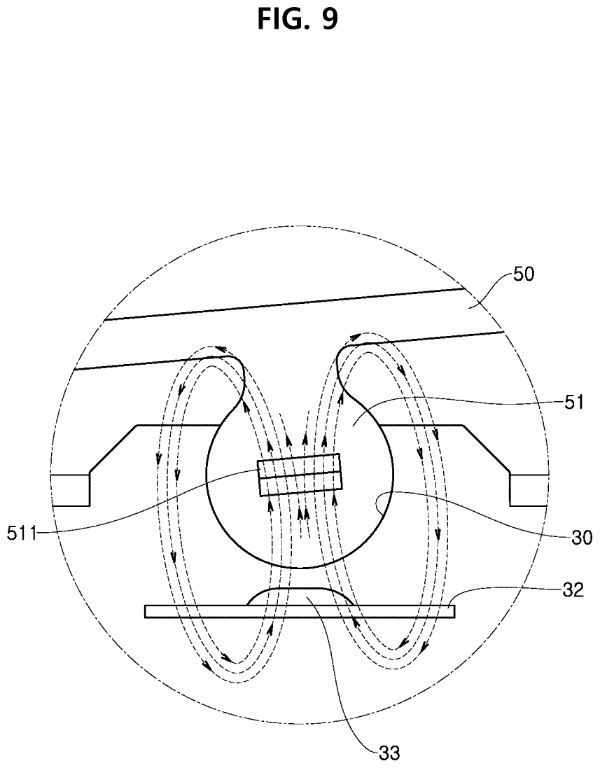

FIG. 9 is a conceptual diagram schematically illustrating a method of measuring a tilt of the moving part 50 of the robotic wrist device 1 according to the exemplary embodiment of the present invention.

As illustrated in FIG. 9, the ball joint 51 of the moving part 50 may further include a magnetic material 511, and in a position corresponding to the magnetic material 511, the central part 30 may include a circuit unit 32 in which a magnetic sensor 33 is embedded. Thus, as the moving part 50 is tilted, the magnetic sensor 33 may detect a change in the magnetic field due to a change in the posture of the magnetic material 511 to detect the movement of the moving part 50 by detecting a rotation angle of the ball joint 51.

In other words, since the magnetic material 511 and the magnetic sensor 33 are located close together, the change in the magnetic flux density due to the change in the posture of the magnetic material 511 may be sensitively measured while minimizing the effect of an external magnetic field.

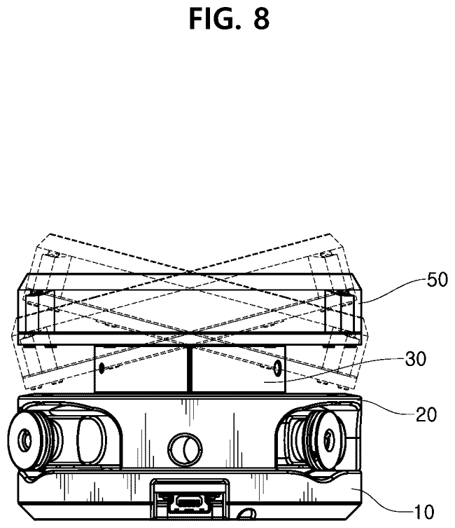

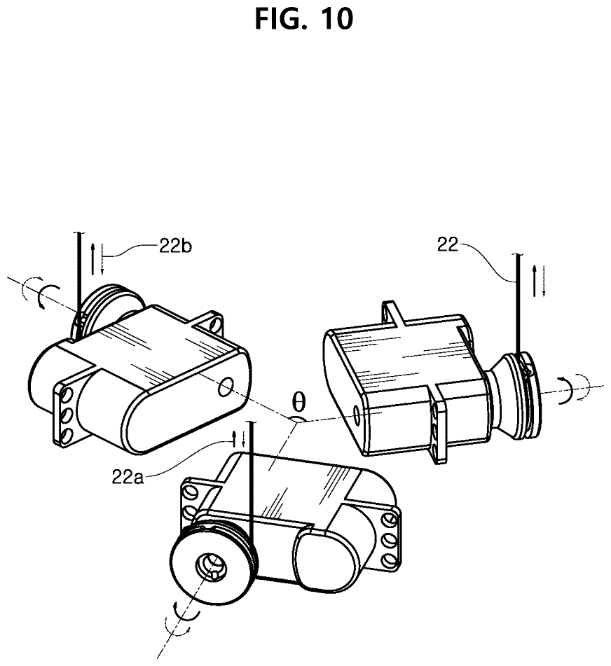

FIG. 8 is a conceptual diagram schematically illustrating an operation mode according to adjusting tension of the wire 22 of the robotic wrist device 1 according to the exemplary embodiment of the present invention, and FIG. 10 is a perspective view schematically illustrating an actuator 21 mounted on the robotic wrist device 1 according to the exemplary embodiment of the present invention.

As illustrated in FIG. 10, the plurality of actuators 21 according to the exemplary embodiment of the present invention may be disposed in phase with the same angle θ in the circumferential direction of the fixing part 20, for example, when three actuators 21 are set, the plurality of actuators 21 may be disposed at an angle of 120° in the circumferential direction of the fixing part 20.

In other words, by disposing the three actuators 21 in the same angular phase radially, the robotic wrist device 1 according to the exemplary embodiment of the present invention is capable performing not only tilt motion, but also conical motion that allows the robotic hand to rotate about the robotic wrist device 1, such as a human wrist.

Specifically, the robotic wrist device 1 according to the exemplary embodiment of the present invention may release or impart predetermined stiffness to the robotic wrist by releasing the wire 22 connected to the respective actuator 21 (22a, releasing the tension of the wire 22) or by pulling the wire 22 (22b, adding tension to the wire 22).

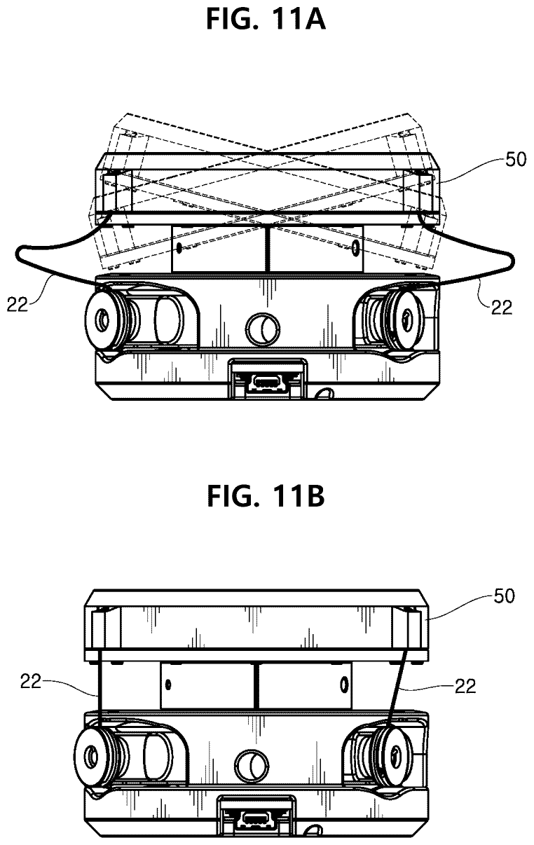

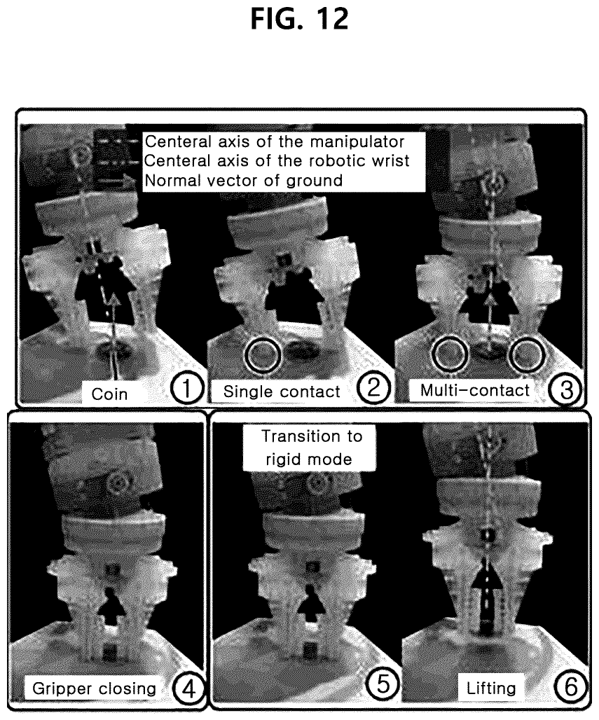

FIG. 11A and FIG. 11B are conceptual diagrams schematically illustrating the behavior of the robotic wrist device 1 in (FIG. 11A) a compliant mode and (FIG. 11B) a rigid mode according to the exemplary embodiment of the present invention, and FIG. 12 is a photograph schematically illustrating the behavior of the robotic wrist device 1 according to the exemplary embodiment of the present invention.

Specifically, when tension is applied to all of the wires 22, the movement of the moving part 50 is limited, so that the robotic wrist device 1 may operate in a fixed rigid mode that locks the movement of the robot wrist. Conversely, when the tension of all of the wires 22 is released, the robotic wrist device 1 may operate in the compliant mode in which the moving part 50 of the robotic wrist device 1 is passively responsive to externally applied force.

Thus, the robotic wrist device 1 according to the exemplary embodiment of the present invention may be utilized as a robotic wrist device of variable stiffness that may be changed between the rigid mode and the compliant mode.

FIG. 12 is a photograph schematically illustrating the behavior of the robotic hand using the robotic wrist device 1 according to the exemplary embodiment of the present invention.

Specifically, in the initial movement process of the robotic wrist device 1 according to the exemplary embodiment of the present invention (FIG. 12-\textcircled{1}), when the rigidity is fixed in the rigid mode, as illustrated in FIG. 12-\textcircled{2}, the movement of the gripper toward the ground is continued while maintaining the rigidity of the robotic wrist device 1 even when the gripper, which is a robotic hand, contacts the ground. Subsequently, when the robotic wrist device 1 is changed to the compliant mode, the robotic wrist device conforms to the ground to occur deformation, and the gripper may be positioned horizontally with the ground.

For example, in order to stably grip a flat object, such as a coin, it is necessary to align the centerline of the gripper with a line perpendicular to the surface of the object, but it is usually difficult to precisely manipulate the centerline of the gripper, so as illustrated in FIG. 12-\textcircled{1}, it can be seen that the centerline of the manipulator and the gripper do not align with a line perpendicular to the surface of the object located on the table.

Therefore, as illustrated in FIG. 12-\textcircled{2}, the position of the gripper on the plane is moved to align with a line perpendicular to the surface of the object, and during this movement process, a single contact is made between the gripper and the ground of the table.

Next, as illustrated in FIG. 12-\textcircled{3}, in the compliant mode of the robotic wrist device 1, the continued position movement of the gripper causes the deformation of the robotic wrist device 1 due to the repulsive force of the ground, and the gripper and the ground come into multiple contacts, and then the movement of the gripper is completed so that the line perpendicular to the coin face, which is perpendicular to the surface of the object, and the center line of the robot and the gripper are aligned. In other words, the compliant mode of the robotic wrist device 1 according to the exemplary embodiment of the present invention allows the robotic wrist to be deformed into a desired position while being compliant with external force until the position of the gripper is determined.

Next, after the gripper has gripped the object in the state where the robotic wrist device 1 is compliant as illustrated in FIG. 12-\textcircled{4}, the gripper is moved as illustrated in FIG. 12-\textcircled{5}. In particular, the posture and the position of the manipulator and the gripper after gripping the object need to be fixed, which requires switching the robotic wrist device 1 from the compliant mode to the rigid mode. Further, since the tilt of the moving part 50 may be accurately measured by the magnetic sensor 33 embedded in the central part 30, the actuation value of the actuator 21 may be accurately calculated to fix the rigid mode of the robotic wrist device 1.

Finally, as illustrated in FIG. 12-\textcircled{6}, it can be seen that even when the contact between the gripper and the ground is removed, the robotic wrist device 1 has been switched to the rigid mode during the process of FIG. 12-\textcircled{5}, so that it can be seen that the object is lifted while the centerline of the gripper remains perpendicular to the ground of the table.

Therefore, using the robotic wrist device 1 having variable stiffness according to the exemplary embodiment of the present invention may be advantageous for grasping flat objects, such as coins, and after grasping the object, the robotic wrist device 1, which has compliant-completed, is switched back to the rigid mode in which the stiffness is fixed as illustrated in FIG. 12-\textcircled{4}, so that a stable grip of the gripper may be maintained, and the correct posture of the gripper may be maintained.

In other words, since the robotic wrist device 1 according to the exemplary embodiment of the present invention may have variable stiffness, it has been confirmed that the robotic wrist device 1 is advantageous to adapt to difficult environments based on the flexibility of the compliant mode and is capable of performing work after stable gripping based on the stiffness of the rigid mode.

With reference to the foregoing descriptions, those skilled in the art to which the present invention belongs will understand that the present invention may be practiced in other specific forms without changing the technical idea or essential features thereof.

Therefore, it is to be understood that the exemplary embodiments described above are exemplary in all respects, and it is to be understood that the present invention is not intended to be limited to the exemplary embodiments, the scope of the invention is indicated by the accompanying claims rather than by the foregoing detailed description, and the meaning and scope of the patent claims and all modifications or variations derived from the equivalents are to be construed as being within the scope of the invention.

What is claimed is:

1. A robotic wrist device with variable stiffness comprising:
a base part;
a fixing part disposed on a top portion of the base part and including a plurality of actuators;
a central part disposed on a top portion of the fixing part and including a socket part formed in an upper direction;
a moving part including a downwardly extending ball joint, and supported on the central part by the ball joint being inserted into and supported on the socket part; and
an elastic member having an inner circumference coupled to the central part at a periphery of the central part and an outer circumference coupled to an outer peripheral portion of the moving part,
wherein the moving part is capable of tilting movement relative to the central part in response to rotation of the ball joint, and
the moving part includes a plurality of connection parts which are connected to the fixing parts through wires connected to the plurality of actuators, respectively.

2. The robotic wrist device with variable stiffness of claim 1, wherein the elastic member is a circular diaphragm spring.

3. The robotic wrist device with variable stiffness of claim 2, wherein the diaphragm spring includes: an inner rim engaged with the central part; an outer rim engaged with the outer peripheral portion of the moving part; and a sheet disposed between the inner rim and the outer rim.

4. The robotic wrist device with variable stiffness of claim 3, wherein in the sheet, a plurality of slits disposed concentrically with the inner rim and the outer rim is formed.

5. The robotic wrist device with variable stiffness of claim 4, wherein the position of the inner rim is fixed and the outer rim is movable in response to movement of the outer peripheral portion of the moving part.

6. The robotic wrist device with variable stiffness of claim 1, wherein the plurality of actuators is disposed in the same angular phase around the circumference of the fixing part.

7. The robotic wrist device with variable stiffness of claim 6, wherein the plurality of actuators are three, and are disposed at an angle of 120° around the circumference of the fixing part.

8. The robotic wrist device with variable stiffness of claim 1, wherein the ball joint further includes a magnetic material,
the central part further includes a circuit unit including a magnetic sensor, and
according to the tilting of the moving part, the movement of the magnetic material is detected by the magnetic sensor, such that a rotation angle of the ball joint is detected.

9. The robotic wrist device with variable stiffness of claim 1, wherein the plurality of actuators each is capable of limiting tilting movement of the moving part by applying tension to the wire.

10. The robotic wrist device with variable stiffness of claim 1, wherein the base part further includes a circuit unit for controlling driving of the plurality of actuators.
